(19) United States
(12) Patent Application Publication
(10) Pub. No.: US 2025/0147198 A1
(43) Pub. Date: May 8, 2025

(54) STEERING APPARATUS

(71) Applicant: Honda Motor Co., Ltd., Tokyo (JP)

(72) Inventor: Shotaro Odate, Tokyo (JP)

(21) Appl. No.: 18/939,405

(22) Filed: Nov. 6, 2024

(30) Foreign Application Priority Data
Nov. 7, 2023 (JP) 2023-189904

(51) Int. Cl. G01V 3/08; B62D 1/06

(52) U.S. Cl. CPC G01V 3/088; B62D 1/06

(57) ABSTRACT

A steering apparatus includes: a steering wheel, and a sensor unit configured to detect contact or close proximity of a human body to the steering wheel. The sensor unit includes: an electrode provided in the steering wheel, a measuring device configured to measure an electrostatic capacitance of the electrode, and a switching element configured to switch the electrode between a first state in which the electrode is grounded and a second state in which the electrode is not grounded.

### CROSS-REFERENCE TO RELATED APPLICATION

This application is based upon and claims the benefit of priority from Japanese Patent Application No. 2023-189904 filed on Nov. 7, 2023, the content of which are incorporated herein by reference.

### BACKGROUND OF THE INVENTION

### Field of the Invention

This invention relates to a steering apparatus for detecting whether a steering wheel is gripped by an occupant.

### Description of the Related Art

As this type of device, a device that detects whether a steering wheel is gripped, based on a change in electrostatic capacitance is known (see, for example, JP 2023-32036 A). JP 2023-32036 A discloses, as countermeasures against electromagnetic noise, a technique for delaying an operation speed of an FET that switches between supply and block of electric power for a heater wire to reduce the electromagnetic noise that affects an output of an electrostatic capacitance sensor.

However, the conventional technique only temporarily stops the supply of the electric power for the heater wire when detecting a change in the electrostatic capacitance, so it is difficult to avoid the influence of the electromagnetic noise generated separately from the heater wire.

The present invention appropriately detects a driver's grip on the steering wheel, while suppressing the influence of the electromagnetic noise, thereby leading to an improvement in traffic safety. This enables a contribution to development of a sustainable transportation system.

### SUMMARY OF THE INVENTION

An aspect of the present invention is a steering apparatus including: a steering wheel; and a sensor unit configured to detect contact or close proximity of a human body to the steering wheel. The sensor unit includes: an electrode provided in the steering wheel; a measuring device configured to measure an electrostatic capacitance of the electrode; and a switching element configured to switch the electrode between a first state in which the electrode is grounded and a second state in which the electrode is not grounded.

### BRIEF DESCRIPTION OF THE DRAWINGS

The objects, features, and advantages of the present invention will become clearer from the following description of embodiments in relation to the attached drawings, in which:

FIG. 1 is a diagram illustrating a configuration of a steering apparatus according to an embodiment and a safe driving assistance system, which includes the steering apparatus;

FIG. 2 is a schematic diagram illustrating grip detection ranges by electrodes;

FIG. 3 is a diagram illustrating a circuit configuration of a sensor unit; and

FIG. 4 is a diagram illustrating a configuration of a substantial part of a controller included in the sensor unit.

### DETAILED DESCRIPTION OF THE INVENTION

Hereinafter, embodiments of the invention will be described with reference to the drawings.

### System Configuration

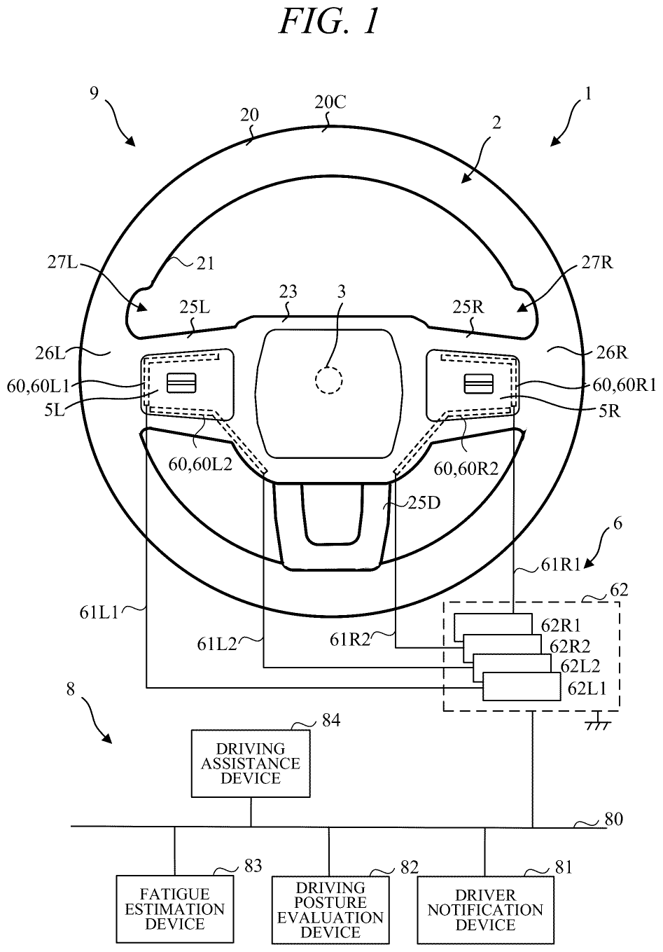

FIG. 1 is a diagram illustrating a configuration of a steering apparatus 1 according to an embodiment and a safe driving assistance system 9, which includes such a steering apparatus 1.

The safe driving assistance system 9 includes: the steering apparatus 1, which is mounted on a vehicle, not illustrated; and a control device group 8, which is communicably connected with the steering apparatus 1. The safe driving assistance system 9 supports driver's safe driving of the vehicle, by using the steering apparatus 1 and the control device group 8.

In an embodiment, each of devices 81 to 84, which constitute the control device group 8, will be described as an in-vehicle device capable of communicating with the steering apparatus 1 on, for example, CAN communication via a controller area network (CAN) bus 80. However, all or some of the plurality of devices 81 to 84, which constitute the control device group 8, may be configured as a device that is outside the vehicle and that is capable of wirelessly communicating with the steering apparatus 1 via an in-vehicle communication device, not illustrated.

### Outline of Steering Apparatus

The steering apparatus 1 includes: a steering wheel 2, which receives a steering operation by a driver for a vehicle, an auxiliary machine operation for an auxiliary machine of the vehicle, and the like; a steering shaft 3, which pivotally supports the steering wheel 2; and a grip detection device 6 that detects a driver's grip on the steering wheel 2. The auxiliary machine operation and the like include operations for a navigation device, an audio device, an air conditioner, a multi-information display, and the like, and an operation for a driving assistance apparatus. The driving assistance apparatus includes, for example, a lane keeping assistant system (LKAS) and an adaptive cruise control (ACC).

The steering wheel 2 includes: for example, a rim portion 20, which has an annular shape, and which the driver is able to grip; a hub portion 23, which is provided on an inner side of the rim portion 20; and three spoke portions 25L, 25R, and 25D, each of which extends from the hub portion 23 along a radial direction, and is connected with a rim inner circumferential portion 21 of the rim portion 20.

The hub portion 23 has a disk shape, and is provided, for example, at the center of the rim portion 20, when viewed from the driver's seat, and constitutes the center of the steering wheel 2. The steering shaft 3, which pivotally supports the steering wheel 2, is coupled with the back surface of the hub portion 23, when viewed from the driver's seat. The steering shaft 3 serves as a coupling member that has a shaft shape and that couples a core metal, which is a skeleton of the hub portion 23, with a steering mechanism, which constitutes a part of a vehicle body, not illustrated. Therefore, steering torque generated by the driver rotating the steering wheel 2 is transmitted by the steering shaft 3 to the steering mechanism.

The rim portion 20 and the hub portion 23 are connected with each other by the three spoke portions 25L, 25R, and 25D. The left spoke portion 25L extends along a horizontal direction, and connects a part on the left side of the hub portion 23 in a front view from the driver's seat with a left spoke connection portion 26L, which is a part on the left side of the rim inner circumferential portion 21 in the front view from the driver's seat. The right spoke portion 25R extends in parallel with the left spoke portion 25L and along the horizontal direction, and connects a part on the right side of the hub portion 23 in the front view from the driver's seat with a right spoke connection portion 26R, which is a part on the right side of the rim inner circumferential portion 21 in the front view from the driver's seat. The lower spoke portion 25D extends along a direction orthogonal and perpendicular to each of the spoke portions 25L and 25R, and connects a part on a lower side of the hub portion 23 in the front view from the driver's seat with a part on a lower side of the rim inner circumferential portion 21 in the front view from the driver's seat.

As illustrated in FIG. 1, in a part, of the rim inner circumferential portion 21, that is connected with an upper portion of the left spoke connection portion 26L in the front view from the driver's seat, a left thumb fit portion 27L, which is concave radially outward is formed in the front view from the driver's seat. In addition, in a part, of the rim inner circumferential portion 21, that is connected with an upper portion of the right spoke connection portion 26R in the front view from the driver's seat, a right thumb fit portion 27R, which is concave radially outward is formed in the front view from the driver's seat.

In the steering apparatus 1 according to an embodiment, a posture in which the thumb of the left hand is fit to the left thumb fit portion 27L and the base of the thumb of the left hand is brought into contact with the left spoke connection portion 26L and the remaining fingers of the left hand grip the rim portion 20 is regarded as a recommended grip posture for the driver's left hand. Therefore, a recommended grip position for the driver's left hand is set to a part including the left spoke connection portion 26L in the rim portion 20.

Further, in the steering apparatus 1 according to an embodiment, a posture in which the thumb of the right hand is fit to the right thumb fit portion 27R and the base of the thumb of the right hand is brought into contact with the right spoke connection portion 26R and the remaining fingers of the right hand grip the rim portion 20 is regarded as a recommended grip posture for the driver's right hand. Therefore, the recommended grip position for the driver's right hand is set to a part including the right spoke connection portion 26R in the rim portion 20.

The left spoke portion 25L and the right spoke portion 25R are respectively provided with a left auxiliary machine operation console unit 5L and a right auxiliary machine operation console unit 5R, each of which receive an auxiliary machine operation for the driver to operate a vehicle auxiliary machine, not illustrated, or the like. The left auxiliary machine operation console unit 5L and the right auxiliary machine operation console unit 5R each have a substantially rectangular shape when viewed from the driver. By operating a plurality of switches provided in the left auxiliary machine operation console unit 5L and the right auxiliary machine operation console unit 5R with fingers, the driver is able to operate the vehicle auxiliary machines and the like.

The left auxiliary machine operation console unit 5L and the right auxiliary machine operation console unit 5R may be respectively referred to as a left function switch unit and a right function switch unit.

In addition, in the following description, the positions of the rim portion 20, which is substantially circular when viewed from the driver, the rim inner circumferential portion 21, the hub portion 23, and the steering shaft 3, and the directions of the respective spoke portions 25L, 25R, and 25D will be represented in some cases by clockwise angles (deg) centered on the steering shaft 3 and based on the position of an upper end portion 20C of the rim portion 20 in the front view from the driver's seat. That is, the right spoke portion 25R extends along a direction of 90 deg, and connects the hub portion 23 with a part of 90 deg of the rim inner circumferential portion 21. The lower spoke portion 25D extends along a direction of 180 deg, and connects the hub portion 23 with a part of 180 deg of the rim inner circumferential portion 21. In addition, the left spoke portion 25L extends along a direction of 270 deg, and connects the hub portion 23 with a part of 270 deg of the rim inner circumferential portion 21. When expressed by the clockwise angle (deg), the recommended grip position for the driver's left hand is set to a position of 270 deg of the rim portion 20.

Further, the recommended grip position for the driver's right hand is set to a position of 90 deg of the rim portion 20.

### Grip Detection Device

As an example, the grip detection device 6 includes an electrode 60, which is provided in the steering wheel 2, and a sensor unit 62, which is electrically connected with the electrode 60. In the following, a first left electrode 60L1 and a second left electrode 60L2, a first right electrode 60R1 and a second right electrode 60R2 will be collectively referred to as the electrode 60, in some cases.

The four electrodes 60L1, 60L2, 60R1, and 60R2 are each formed in a plate shape with electric conductivity. The first left electrode 60L1 and the second left electrode 60L2 are provided in the vicinity of the recommended grip position for the left hand set to the rim portion 20 in the steering wheel 2. More specifically, the first left electrode 60L1 is provided along a side wall face in an upper part and on a radially outer side of the left auxiliary machine operation console unit 5L in the left spoke portion 25L when viewed from the driver (more specifically, on an end face of a printed wiring board (may also be referred to as an electronic board), not illustrated, disposed inside the left auxiliary machine operation console unit 5L). In addition, the second left electrode 60L2 is provided along a face that faces the rim portion 20 in a lower part of the left auxiliary machine operation console unit 5L (more specifically, on an end face of the above printed wiring board) in the left spoke portion 25L and in a left lower part of the hub portion 23 when viewed from the driver.

Similarly, the first right electrode 60R1 and the second right electrode 60R2 are provided in the vicinity of the recommended grip position for the right hand set to the rim portion 20 in the steering wheel 2. More specifically, the first right electrode 60R1 is provided along a side wall face in an upper part and on a radially outer side of the right auxiliary machine operation console unit 5R in the right spoke portion 25R when viewed from the driver (more specifically, on an end face of a printed wiring board disposed inside the right auxiliary machine operation console unit 5R). In addition, the second right electrode 60R2 is provided along a face that faces the rim portion 20 in a lower part of the right auxiliary machine operation console unit 5R (more specifically, on an end face of the above printed wiring board) in the right spoke portion 25R and in a right lower part of the hub portion 23 when viewed from the driver.

### Sensor Unit

The sensor unit 62 includes four sensor units 62L1, 62L2, 62R1, and 62R2, which respectively correspond to the four electrodes 60L1, 60L2, 60R1, and 60R2. The sensor unit 62L1 is connected with the first left electrode 60L1 through left wiring 61L1. The sensor unit 62L2 is connected with the second left electrode 60L2 through left wiring 61L2.

In addition, the sensor unit 62R1 is connected with the first right electrode 60R1 through right wiring 61R1. Furthermore, the sensor unit 62R2 is connected with the second right electrode 60R2 through right wiring 61R2.

The sensor units 62L1 and 62L2 are, for example, provided inside the left spoke portion 25L, together with the above-described left auxiliary machine operation console unit 5L. The sensor units 62R1 and 62R2 are provided inside the right spoke portion 25R, together with the above-described right auxiliary machine operation console unit 5R.

### Grip Detection Range

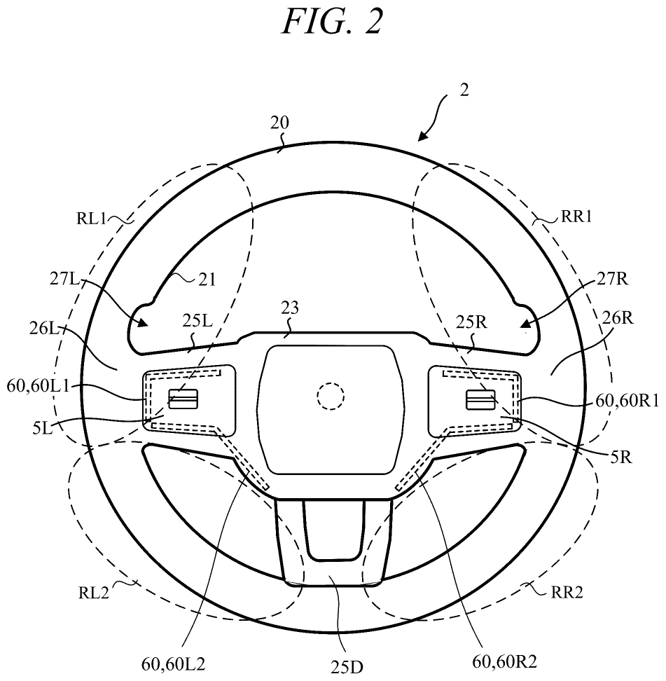

FIG. 2 is a schematic diagram illustrating grip detection ranges RL1, RL2, RR1, and RR2 by the electrode 60 (60L1, 60L2, 60R1 and 60R2) as described above. When a predetermined voltage is applied to the corresponding electrodes 60L1, 60L2, 60R1, and 60R2 in the respective grip detection ranges RL1, RL2, RR1, and RR2, lines of electric force are induced from these electrodes 60L1, 60L2, 60R1, and 60R2.

In an embodiment, as described above, the first left electrode 60L1 is provided in the left spoke portion 25L in the vicinity of the recommended grip position (270 deg) of the rim portion 20 for the left hand, and the second left electrode 60L2 is provided in the hub portion 23 in the vicinity of the recommended grip position (270 deg to 180 deg) of the rim portion 20 for the left hand.

With such a configuration, the grip detection ranges RL1 and RL2 correspond to a range of 210 deg to 260 deg and a range of 260 deg to 330 deg, with the recommended grip position for the left hand as the center in the rim portion 20.

Similarly, the first right electrode 60R1 is provided in the right spoke portion 25R in the vicinity of the recommended grip position (90 deg) of the rim portion 20 for the right hand, and the second right electrode 60R2 is provided in the hub portion 23 in the vicinity of the recommended grip position (90 deg to 180 deg) of the rim portion 20 for the right hand.

With such a configuration, the grip detection ranges RR1 and RR2 respectively correspond to a range of 100 deg to 150 deg and a range of 30 deg to 100 deg, with the recommended grip position for the right hand as the center in the rim portion 20.

### Circuit Configuration Example

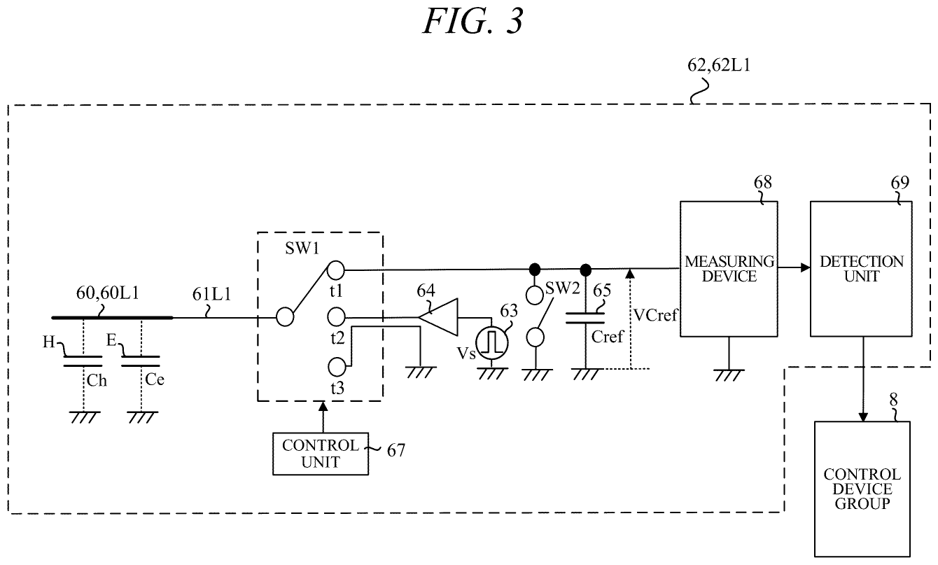

FIG. 3 is a diagram illustrating a circuit configuration of the sensor unit 62L1 in the grip detection device 6. Although not illustrated, the same configuration also applies to the circuit configurations of the sensor units 62L2, 62R1, and 62R2 except for the sensor unit 62L1.

The sensor unit 62L1 measures an electric property of the left electrode 60L1 (for example, electrostatic capacitance between the left electrode 60L1 and the ground (for example, the vehicle body)), detects the driver's grip on the steering wheel 2, based on a measurement result, and further estimates the driver's grip position in the rim portion 20.

The sensor unit 62L1 includes a first switch SW1, a pulse power source 63, an amplifier 64, a control unit 67, a second switch SW2, a charging capacitor 65, a measurement unit 68, and a detection unit 69, and detects the driver's grip on the steering wheel 2 by using them.

Note that in FIG. 3, the electrostatic capacitance between the first left electrode 60L1 and the ground is illustrated to be divided into electrostatic capacitance Ch, which is formed by a human body H including a hand of the driver who operates the steering wheel 2, and stray capacitance Ce, which is formed by a stray capacitor E such as wiring or a component part excluding the human body H.

As illustrated in FIG. 3, the pulse power source 63 and the amplifier 64 are connected in series with each other. In addition, the second switch SW2 and the charging capacitor 65 are connected in parallel with each other. A series circuit including the pulse power source 63 and the amplifier 64 and a parallel circuit including the second switch SW2 and the charging capacitor 65 are connected with each other through the first switch SW1. More specifically, an output terminal of the amplifier 64 and the first left electrode 60L1 are connected with each other through the first switch SW1 and the left wiring 61L1. Further, the second switch SW2 and the charging capacitor 65 are connected with the first left electrode 60L1 through the first switch SW1 and the left wiring 61L1.

In response to, for example, a command from the control unit 67, the pulse power source 63 supplies the amplifier 64 with a pulse voltage Vs having a predetermined frequency and a predetermined voltage. The amplifier 64 amplifies the pulse voltage Vs, which is supplied from the pulse power source 63, and applies the amplified pulse voltage to the first left electrode 60L1 through the first switch SW1 and the left wiring 61L1.

The second switch SW2 is, for example, a switching element such as a transistor to be turned on/off by a drive circuit, not illustrated, in the control unit 67. As an example, until a voltage VCref of the charging capacitor 65 reaches a predetermined voltage threshold Vthr, the control unit 67 turns off the second switch SW2 to accumulate electric charge in the charging capacitor 65 (may also be referred to as charging). After the voltage VCref reaches the threshold Vthr, the control unit 67 further turns on the second switch SW2, and discharges the electric charge accumulated in the charging capacitor 65.

The first switch SW1 is, for example, a switching element, switching of which is controlled by a drive circuit, not illustrated, in the control unit 67, and is configured with a field effect transistor (FET) or the like as an example. In an embodiment, a terminal t1 for connecting the first left electrode 60L1 with the charging capacitor 65, a terminal t2 for connecting the first left electrode 60L1 with the amplifier 64, and a terminal t3 for connecting the first left electrode 60L1 with the ground line are included.

The ground line is equipotential to a GND pattern of a printed circuit board (PCB) on which circuits excluding the first left electrode 60L1 of the circuits of the sensor unit 62L1 are formed, and is provided substantially in parallel with at least one of a wiring pattern to the above terminal t1 and a wiring pattern to the above terminal t2. In FIG. 3, the ground line is illustrated in parallel with the wiring pattern to the terminal t2.

The ground line (GND pattern) disposed near a signal line (the wiring pattern to the terminal t2) enables strengthening of electromagnetic coupling between the signal line and the ground line, and enables suppression of coupling between the signal line and any other pattern on the PCB. In other words, a signal of another pattern on the PCB being transmitted as noise to the signal line due to a leakage current or the like that flows on the surface of the PCB is suppressed, and in reverse, a signal of the signal line being transmitted as noise to any other pattern on the PCB is suppressed.

According to a command from the control unit 67, the first switch SW1 selects the terminal t1 of the first switch SW1 in accordance with a rise of the pulse voltage Vs of the pulse power source 63. This connects the first left electrode 60L1 with the amplifier 64 through the first switch SW1 and the left wiring 61L1, applies the pulse voltage supplied from the pulse power source 63 and the amplifier 64 to the first left electrode 60L1, and charges the human body H and the stray capacitor E.

Subsequently, according to a command from the control unit 67, the first switch SW1 selects the terminal t2 of the first switch SW1 in accordance with a fall of the pulse voltage Vs of the pulse power source 63. This connects the first left electrode 60L1 with the charging capacitor 65 through the first switch SW1 and the left wiring 61L1, moves the electric charge that has been charged in the human body H and the stray capacitor E to the charging capacitor 65, and charges the charging capacitor 65. Accordingly, the voltage VCref of the charging capacitor 65 increases.

In this manner, when the pulse voltage is repeatedly applied to the first left electrode 60L1 by the pulse power source 63 and the amplifier 64, charging and discharging of the human body H and the stray capacitor E are alternately repeated, and the voltage VCref of the charging capacitor 65 gradually increases. In this situation, the time until the voltage VCref of the charging capacitor 65 reaches the predetermined voltage threshold Vthr (may be represented by the number of pulses of the pulse power source 63) changes in accordance with the electrostatic capacitance Ch, which is formed by the human body H, that is, a relative position to the first left electrode 60L1 of a hand of the driver who operates the steering wheel 2. That is, in a case where the driver's hand grips a part in the rim portion 20 within the grip detection range RL1 (see FIG. 2) and the electrostatic capacitance Ch increases, the time taken for the voltage VCref of the charging capacitor 65 to reach the threshold Vthr decreases. In a case where the driver's hand is apart from the grip detection range RL1 and the electrostatic capacitance Ch decreases, the time taken for the voltage VCref of the charging capacitor 65 to reach the voltage threshold Vthr increases.

Furthermore, according to a command from the control unit 67, the first switch SW1 selects the terminal t3 of the first switch SW1 at a predetermined timing. This connects the first left electrode 60L1 with the ground line through the first switch SW1 and the left wiring 61L1, and discharges the electric charge that has been charged on the human body H and in the stray capacitor E and the electric charge that remains in the first left electrode 60L1 and the left wiring 61L1 to the ground line.

In a case of selecting, for example, the terminal t1 of the above-described first switch SW1 and in a case of selecting the terminal t2 of the first switch SW1, the control unit 67 outputs a command to the first switch SW1 to select the terminal t3 temporarily, and then to select the terminal t1 and the terminal t2.

In addition, the control unit 67 may output a command to the first switch SW1 to select the terminal t3 of the first switch SW1 so as to match the timing of turning on the second switch SW2 (in other words, to discharge the electric charge stored in the charging capacitor 65).

Furthermore, a command may be output to the first switch SW1 to select the terminal t3 of the first switch SW1 so as to match the timing when another auxiliary machine operates.

The timing of selecting the terminal t3 of the first switch SW1 is configured to be appropriately changeable by a program executed by the control unit 67.

The measurement unit 68 measures the electrostatic capacitance Ch, which is formed by the human body H. More specifically, the measurement unit 68 detects the time and the number of pulses until the voltage VCref of the charging capacitor 65 reaches the threshold Vthr, and converts such a detected value into the electrostatic capacitance Ch, which is formed by the human body H that is present in the vicinity of the first left electrode 60L1. The measurement unit 68 outputs a measured value Ch_d of the electrostatic capacitance Ch that has been obtained in the above procedure to the detection unit 69.

The detection unit 69 detects the driver's grip on the rim portion 20, based on the electrostatic capacitance measured value Ch_d by the measurement unit 68, and also estimates the grip position in the rim portion 20, upon detection of the grip on the rim portion 20. The detection unit 69 estimates that a position (for example, 260 deg) closer to the left spoke portion 25L in the rim portion 20 is gripped, as the value of the electrostatic capacitance measured value Ch_d increases when the grip is detected, and estimates that a position (for example, 210 deg) farther from the left spoke portion 25L in the rim portion 20 is gripped, as the value of the electrostatic capacitance measured value Ch d decreases when the grip is detected.

As described heretofore, the detection unit 69 of the sensor unit 62L1 detects the driver's grip in the grip detection range RL1 of the rim portion 20, based on the measured value Ch_d of the electrostatic capacitance Ch, which is formed by the human body H that is present in the vicinity of the first left electrode 60L1, and estimates the grip position on the rim portion 20.

Note that although the description is omitted, the detection of the grip and the estimation of the grip position in the grip detection range RL2 of the rim portion 20 by the sensor unit 62L2, the detection of the grip and the estimation of the grip position in the grip detection range RR1 of the rim portion 20 by the sensor unit 62R1, and the detection of the grip and the estimation of the grip position in the grip detection range RR2 of the rim portion 20 by the sensor unit 62R2 are also similar to the detection of the grip and the estimation of the grip position in the grip detection range RL1 of the rim portion 20 by the sensor unit 62L1 described above.

### Countermeasures Against Leakage Current

In the measurement of the electrostatic capacitance Ch by the sensor unit 62L1 as described above, minute signals are handled. Hence, it is necessary to take countermeasures against leakage current that flows on the surface of the PCB. In general, a technique for surrounding a circuit formed on a PCB with a shield pattern having the same potential as that of a signal line to disperse and relax an electric field concentrated on a specific part on the circuit (also referred to as a guard ring) is known. In the guard ring, the effect of suppressing the leakage current is obtained, whereas it is necessary to surround the circuit with the shield pattern, thereby causing an adverse effect of increasing the outer size of the PCB.

On the other hand, by selecting the terminal t3 of the first switch SW1, which is adopted in the present embodiment, an effect of suppressing the leakage current equivalent to at least the guard ring is obtainable. That is, even though the guard ring is not adopted, it becomes possible to suppress accumulation of unnecessary electric charge in the left electrode 60L1 via the leakage current or the like that flows on the surface of the PCB, and to suppress generation of unnecessary electric charge in an electric charge transfer passage from the left electrode 60L1 to the charging capacitor 65. Thus, it becomes possible to suppress the influence on the measurement of the electrostatic capacitance Ch of the human body H and the stray capacitor E.

In addition, by eliminating the guard ring that surrounds the circuit, it becomes possible to downsize the PCB and to improve the degree of freedom of the layout of component parts such as the left electrode 60L1, accordingly.

### Main Configuration of Controller

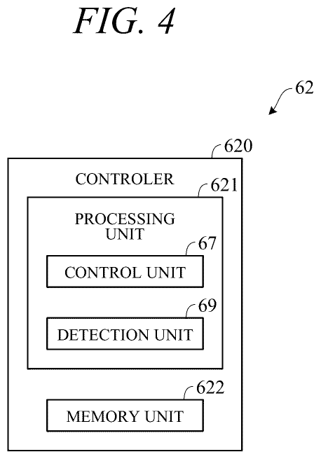

FIG. 4 is a diagram illustrating a configuration of a substantial part of a controller 620, which is included in the sensor unit 62 including the sensor units 62L1, 62L2, 62R1 and 62R2. As illustrated in FIG. 4, the controller 620 includes a computer including a processing unit such as a CPU (microprocessor) and a storage unit 622 such as a ROM and a RAM. By executing a program stored in the storage unit 622, a processing unit 621 functions as the control unit 67 and the detection unit 69 in FIG. 3. That is, the processing unit 621 includes the control unit 67 and the detection unit 69 in FIG. 3, as a functional configuration. The processing unit 621 may include the control unit 67 and the detection unit 69 individually or in common for the sensor units 62L1, 62L2, 62R1 and 62R2.

According to the above-described embodiments, the following effects are obtainable.
(1) The steering apparatus 1 includes: the steering wheel 2; and the sensor unit 62, which detects contact or close proximity of a human body to the steering wheel 2. The sensor unit 62L1 includes: the left electrode 60L1, which is provided in the steering wheel 2; the measurement unit 68, which measures the electrostatic capacitance Ch of the left electrode 60L1; and the first switch SW1 as a switching element of switching the left electrode 60L1 between a first state in which the left electrode 60L1 is grounded and a second state in which the left electrode 60L1 is not grounded.

With such a configuration, for example, by switching the first switch SW1 to the first state, it becomes possible to discharge unnecessary electric charge accumulated in the left electrode 60L1 due to leakage current or the like that flows on the PCB surface. On the other hand, when measuring the electrostatic capacitance Ch of the human body H and the stray capacitor E, by switching the first switch SW1 to the second state, it becomes possible to move the electric charge that has been accumulated in the left electrode 60L1 toward the measurement unit 68. This enables appropriate detection of the grip on the steering wheel 2.
(2) In the steering apparatus 1 of the above (1), the sensor unit 62L1 further includes: the control unit 67, which controls the first switch SW1; and the charging capacitor 65 as a capacitive element. The above second state includes a third state in which the voltage from the pulse power source 63 as a predetermined power source is applied to the left electrode 60L1 through the first switch SW1, and a fourth state in which the left electrode 60L1 is connected with the charging capacitor 65 through the first switch SW1. The first switch SW1 switches the left electrode 60L1 to the first state, the third state as the above second state, and the fourth state as the above second state, based on a command (control signal) from the control unit 67.

With such a configuration, only by switching the first switch SW1 based on the control signal from the control unit 67, it becomes possible to switch among three modes of the first state, the third state, and the fourth state.
(3) In the steering apparatus 1 of the above (2), the electric charge of the left electrode 60L1 is accumulated in the third state, is moved to the charging capacitor 65 in the fourth state, and is discharged to the ground line in the first state.

With such a configuration, only by switching the first switch SW1 based on the control signal from the control unit 67, it becomes possible to accumulate electric charge in the left electrode 60L1, to move the electric charge to the charging capacitor 65 on the measurement unit 68 side, and to discharge unnecessary electric charge accumulated in the left electrode 60L1 due to leakage current or the like.
(4) In the steering apparatus 1 of the above (3), for example, in the sensor unit 62L1, at least the first switch SW1, the charging capacitor 65, and the measurement unit 68 are configured on a PCB as an electronic board. At least one of signal line patterns that respectively connect the first switch SW1 with the left electrode 60L1, connect the first switch SW1 with the pulse power source 63, and connect the first switch SW1 with the charging capacitor 65 is formed in close proximity to the ground line.

With such a configuration, by selecting the terminal t3 of the first switch SW1 (corresponding to the first state in which the left electrode 60L1 is grounded), an effect corresponding to the guard ring that suppresses the leakage current is obtainable. That is, even though the guard ring is not adopted, it becomes possible to suppress accumulation of unnecessary electric charge in the left electrode 60L1 via the leakage current or the like that flows on the surface of the PCB, and to suppress generation of unnecessary electric charge in an electric charge transfer passage from the left electrode 60L1 to the charging capacitor 65. Thus, it becomes possible to suppress the influence on the measurement of the electrostatic capacitance Ch of the human body H and the stray capacitor E, and to improve measurement accuracy.

In addition, the provision of the ground line near the signal line pattern strengthens electromagnetic coupling between the signal line pattern and the ground line, so that crosstalk between the signal line pattern and another signal line pattern on the PCB can be prevented.

Furthermore, by eliminating the guard ring that surrounds the circuit, it becomes possible to downsize the PCB, and to improve the degree of freedom of the layout of component parts such as the left electrode 60L1, accordingly.
(5) In the steering apparatus 1 of the above (1), the steering wheel 2 includes: the rim portion 20 having an annular shape; the hub portion 23, which is provided on an inner side of the rim portion 20; and the spoke portions 25L, 25R, and 25D, which extend from the hub portion 23 in the radial direction of the rim portion 20, and which connect the hub portion 23 with the inner circumferential portion of the rim portion 20. For example, the sensor unit 62L1 (or the sensor unit 62R1) is disposed in the left auxiliary machine operation console unit (left function switch unit) 5L (or the right auxiliary machine operation console unit (right function switch unit) 5R), which is disposed on the spoke portion 25L (or which is disposed on the right spoke portion 25R).

In general, it is easy to ensure the space in the spoke portion to be broader than the space in the rim portion. Therefore, with a configuration of the above (5), it becomes possible to enhance the production performance, as compared with a case where the sensor unit is insert-molded in the rim portion of the steering wheel.
(6) In the steering apparatus 1 of the above (5), the plurality of spoke portions 25L, 25R, and 25D are provided between the rim portion 20 to be gripped by an occupant and the hub portion 23. For example, the sensor units 62L1 and 62L2, and the sensor units 62R1 and 62R2 are respectively disposed on the left spoke portion 25L and the right spoke portion 25R in a front view from the driver's seat out of the plurality of spoke portions 25L, 25R, and 25D, and are also disposed in close proximity to a switch or the like as a component part for performing at least one operation of a vehicle information operation or a driving support function operation in the left auxiliary machine operation console unit (left function switch unit) 5L and the right auxiliary machine operation console unit (right function switch unit) 5R.

With such a configuration, the PCBs of the sensor units 62L1 and 62L2, and the sensor units 62R1 and 62R2 are respectively disposed on the left auxiliary machine operation console unit (left function switch unit) 5L and the right auxiliary machine operation console unit (right function switch unit) 5R, which are disposed as a pair in the left and right spoke portions 25L and 25R, so that the grip in the left and right recommended grip ranges of the rim portion 20 can be appropriately detected.
(7) In the steering apparatus 1 of the above (6), the sensor unit 62 (62L1, 62L2, 62R1, 62R2) has a configuration other than at least the electrode 60 (60L1, 60L2, 60R1, 60R2) on a PCB as an electronic board. For example, the plurality of electrodes 60 (60L1, 60L2, 60R1, 60R2) of the sensor units 62, which are disposed on the spoke portions 25L and 25R, are provided to correspond to recommended grip ranges that are predetermined grip ranges of the rim portion 20 on the left and the rim portion 20 on the right of the steering wheel 2 in a front view, and each electrode is disposed along an end face of the PCB.

With such a configuration, it becomes possible to appropriately dispose the plurality of electrodes 60 (60L1, 60L2, 60R1, 60R2), for example, in a space (end faces that surround the PCB) generated by a reduction in size of the PCB due to elimination of the guard ring that surrounds the circuit of the sensor units 62L1, 62L2, 62R1, and 62R2.

The above embodiment can be modified into various forms. Hereinafter, modifications will be described.

### First Modification

In an embodiment, the annular steering wheel has been exemplified as the steering wheel 2. However, the present invention may also be applied to a case where a non-annular steering wheel having an irregular shape such as a quadrangular shape or a rod shape is used.

### Second Modification

In an embodiment, four electrodes including the first left electrode 60L1, the second left electrode 60L2, the first right electrode 60R1, and the second right electrode 60R2 have been exemplified as the plurality of electrodes 60. However, the number of electrodes may be larger or smaller than the four exemplified electrodes.

In addition, the four sensor units 62L1, 62L2, 62R1, and 62R2 have been exemplified respectively corresponding to the four exemplified electrodes 60L1, 60L2, 60R1, and 60R2. However, the number of sensor units 62 may be increased or decreased in accordance with the number of electrodes 60.

Further, in an embodiment, the case where one electrode 60 corresponds to one sensor unit 62 has been exemplified. However, a plurality of electrodes 60 may correspond to one sensor unit 62. For example, one sensor unit 62, which is disposed in the left spoke portion 25L in a front view, corresponds to the first left electrode 60L1 and the second left electrode 60L2, and in addition, another sensor unit 62, which is disposed in the right spoke portion 25R in the front view, corresponds to the first right electrode 60R1 and the second right electrode 60R2.

Furthermore, the left and right sensor units 62 may be integrated into one. In the case of integration, one integrated sensor unit 62 may be disposed in any of the left spoke portion 25L, the right spoke portion 25R, and the lower spoke portion 25D.
Third Modification

In an embodiment, an example in which the measurement unit 68 as a measuring device is configured on a PCB as an electronic board has been described. However, the measurement unit 68 may be partially included in the processing unit 621. Specifically, the measuring device may detect the voltage VCref of the charging capacitor 65, and may output a detected value to the processing unit. Then, the processing unit may function as a conversion unit that detects the time and the number of pulses until a detected value (voltage VCref) from the measuring device reaches the threshold Vthr, and converts the detected value into the electrostatic capacitance Ch, which is formed by the human body H that is present in the vicinity of the first left electrode 60L1. In this case, the conversion unit outputs the electrostatic capacitance measured value Ch_d obtained by the conversion to the detection unit 69, and the detection unit 69 detects the driver's grip on the rim portion 20, based on the electrostatic capacitance measured value Ch_d from the conversion unit.

The above embodiment can be combined as desired with one or more of the above modifications. The modifications can also be combined with one another.

According to the present invention, it becomes possible to appropriately detect the grip on the steering wheel.

Above, while the present invention has been described with reference to the preferred embodiments thereof, it will be understood, by those skilled in the art, that various changes and modifications may be made thereto without departing from the scope of the appended claims.

What is claimed is:

1. A steering apparatus comprising:
a steering wheel; and
a sensor unit configured to detect contact or close proximity of a human body to the steering wheel, wherein
the sensor unit comprises:
an electrode provided in the steering wheel;
a measuring device configured to measure an electrostatic capacitance of the electrode; and
a switching element configured to switch the electrode between a first state in which the electrode is grounded and a second state in which the electrode is not grounded.

2. The steering apparatus according to claim 1, wherein
the sensor unit further comprises a microprocessor and a capacitive element, and wherein
the microprocessor is configured to perform controlling the switching element,
the second state includes a third state in which a voltage from a predetermined power source is applied to the electrode through the switching element, and a fourth state in which the electrode is connected with the capacitive element through the switching element, and the switching element switches the electrode to the first state, the third state, and the fourth state, based on a control signal from the microprocessor.

3. The steering apparatus according to claim 2, wherein
an electric charge of the electrode is accumulated in the third state, is moved to the capacitive element in the fourth state, and is discharged to a ground line in the first state.

4. The steering apparatus according to claim 3, wherein
the microprocessor is configured to perform
the controlling including, when switching the electrode to the third state or the fourth state, outputting the control signal to the switching element to switch the electrode to the third state or the fourth state after temporarily switching the electrode to the first state.

5. The steering apparatus according to claim 3, wherein
in the sensor unit, at least the switching element, the capacitive element, and the measuring device are configured on an electronic board, and at least one of signal line patterns respectively connecting the switching element with the electrode, the switching element with the predetermined power source, and the switching element with the capacitive element is formed in close proximity to the ground line.

6. The steering apparatus according to claim 1, wherein
the steering wheel comprises:
a rim portion having an annular shape;
a hub portion provided on an inner side of the rim portion; and
a spoke portion extending from the hub portion in a radial direction of the rim portion and connecting the hub portion with an inner circumferential portion of the rim portion, and
the sensor unit is disposed in a function switch unit disposed on the spoke portion.

7. The steering apparatus according to claim 6, wherein
the spoke portion is provided on a left side and a right side in a front view from a driver seat between the rim portion to be gripped by an occupant and the hub portion, and the sensor unit is disposed on the spoke portion on the left side and the spoke portion on the right side, and is also disposed in close proximity to a component part for performing at least one operation of a vehicle information operation or a driving support function operation in the function switch unit.

8. The steering apparatus according to claim 7, wherein
the sensor unit has configurations other than the electrode on as an electronic board, and
the electrode is provided to correspond to each of a predetermined grip range of the rim portion on the left side and a predetermined grip range of the rim portion on the right side, and is disposed along an end face of the electronic board.
